(19) United States
(12) Patent Application Publication
(10) Pub. No.: US 2020/0339340 A1
(43) Pub. Date: Oct. 29, 2020

(54) PACKAGE FOR STORING AND DISPENSING FOOD PRODUCTS, AND METHOD OF USING THEREOF

(71) Applicant: F.R. Drake Company, Waynesboro, VA (US)

(72) Inventors: Robert L. BAMBURG, JR., Amherst, VA (US); George E. REED, Waynesboro, VA (US); André G. RICHARDS, Charlottesville, VA (US)

(21) Appl. No.: 16/856,725

(22) Filed: Apr. 23, 2020

Related U.S. Application Data
(60) Provisional application No. 62/837,885, filed on Apr. 24, 2019.

(51) Int. Cl. B65D 83/04; B65G 1/16; B65G 1/14; B65G 59/00; A47J 47/01

(52) U.S. Cl. CPC B65D 83/0463; B65G 1/16; B65G 1/14; B65G 2814/031; A47J 47/01; B65G 2201/0202; B65G 59/005

(57) ABSTRACT

A food product package for storing and dispensing food products. The food product package comprises a container including a bottom wall and a continuous sidewall extending from the bottom wall and connected to the bottom wall so as to form a storage cavity within the container, a plurality of food products disposed within the storage cavity, a single strip interleaving the food products, and a peelable top film bonded onto the continuous sidewall of the container thereby to seal the storage cavity within the container. The peelable top film peelable off the continuous sidewall of the container so as to open the storage cavity and provide access to the food products disposed within the container.

### CROSS-REFERENCE TO RELATED APPLICATION AND CLAIM TO PRIORITY

This application claims the benefit of U.S. Provisional Patent Application Ser. No. 62/837,885 filed Apr. 24, 2019 by Bamburg, Jr. et al., which is hereby incorporated herein by reference in its entirety and to which priority is claimed.

### FIELD OF THE INVENTION

The present invention relates to automated food processing, and more particularly to a package of food products that is configured and formed to enable automation of dispensing of the food products from the package for cooking.

### BACKGROUND OF THE INVENTION

Within the restaurant industry the rising cost of labor, high turnover rates, and shortage of workers has created demand to reduce kitchen staff. As people in the restaurant industry are finding out, the task of fully automating the process of cooking of food is difficult to impossible using the existing packaging that the food products come in. Thus, there is a need for solving the problem of packaging of food products, and also of stacking the food products in a package so that the food products can be easily and properly automated in the environment of a commercial kitchen.

Another challenge in the kitchen is sanitation. Typically, every time a kitchen worker touches raw meat, they are required to wash their hands to prevent spreading of pathogens. Anything that can reduce the risk of contamination is of a great value.

Moreover, with the increased popularity of hamburgers, many machines have been developed to manufacture preformed hamburgers for use in restaurants, fast-food retailing outlets and for sale in supermarkets. Most of these machines are designed to take prechopped meat and form it into meat patties of a predetermined size in diameter and thickness, then stack the patties for further handling. One of the major problems that has been encountered with the operation of the stacks of the meat patties is that dispensing of the raw meat parries from the stacks cannot be easily automated in the environment of a commercial kitchen.

Recent food trends indicate that consumers prefer that hamburgers and the like be made from raw or uncooked patties that are cooked where consumed. Raw or uncooked patties do not have the structural strength provided by frozen patties. Further, raw patties do not have the shelf life of frozen patties. Packaging and systems developed for frozen patties thus may not be suitable for use with raw or uncooked patties.

Therefore, a food product package containing a stack of food products is susceptible to improvements. With this in mind, a need exists to develop a food product package for arranging food products into a stack so that the food products can be safely, easily and conveniently dispensed as needed from the food product package, and so that dispensing of the food products can be easily and properly automated in the environment of a commercial kitchen.

### BRIEF SUMMARY OF THE INVENTION

According to a first aspect of the invention, there is provided a food product package for storing and dispensing food products. The food product package comprises a container including a bottom wall and a continuous sidewall extending from the bottom wall and connected to the bottom wall so as to form a storage cavity within the container, a plurality of food products disposed within the storage cavity, a single strip interleaving the food products, and a peelable top film bonded onto the continuous sidewall of the container to thereby to seal the storage cavity and food products within the container. The peelable top film is easily removed from the continuous sidewall of the container so as to open the storage cavity and provide access to the food products disposed within the container.

According to a second aspect, a method of operating a food product package for storing and dispensing food products is disclosed. The method comprises the steps of providing a food product package for storing food products. The package includes a container having a bottom wall and a continuous sidewall extending outwardly from the bottom wall. A plurality of food products are disposed within the container, with a single strip interleaving the food products. A peelable top film is bonded onto the continuous sidewall of the container. The peelable top film is removed and access to the food products provided by pulling the film away from the sidewall of the container to open the container. The food products are dispensed from the container one at a time by pulling the paper strip away from the container.

These and other objects of the invention, including apparatus, devices, systems, processes, and the like which constitute part of the invention, will become more apparent to one of ordinary skill in the art upon reading the following detailed description of the exemplary embodiment(s) and drawings.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals. In these drawings:

FIG. 1 depicts a perspective view of a food product package in accordance with a first exemplary embodiment of the present invention;

FIG. 2 depicts a side view of a pack of food products;

FIG. 3 depicts a perspective view of an open food product package;

FIG. 4 depicts a perspective view of the open food product package with the food products being pulled out of the food product package;

FIG. 5 is a side view of the open food product package with the food products being pulled out of the food product package;

FIG. 6 depicts a perspective view of a food product package in accordance with a second exemplary embodiment of the present invention;

FIG. 7 depicts a perspective view of a stack of food products in accordance with the second exemplary embodiment;

FIG. 8 depicts a side view of the stack of the food products of FIG. 7; and

FIG. 9 is a perspective view of the open food product package in accordance with the second exemplary embodiment with the food products being removed from the food product package.

### DETAILED DESCRIPTION OF PREFERRED EMBODIMENT(S)

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “inner” and “outer”, “inside” and “outside.” “horizontal” and “vertical,” “front” and “rear,” “upper” and “lower,” “top” and “bottom” as well as derivatives thereof (e.g., “horizontally,” “downwardly,” “upwardly,” etc.) should be construed to refer to the orientation as then described or as shown in the drawing figure under discussion and to the orientation relative to a vehicle body. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows pertinent structures to operate as intended by virtue of that relationship. The term “integral” (or “unitary”) relates to a part made as a single part, or a part made of separate components fixedly (i.e., non-moveably) connected together. Additionally, the words “a” and/or “an” as used in the claims mean “at least one” and the word “two” as used in the claims means “at least two”. For the purpose of clarity, some technical material that is known in the related art has not been described in detail in order to avoid unnecessarily obscuring the disclosure.

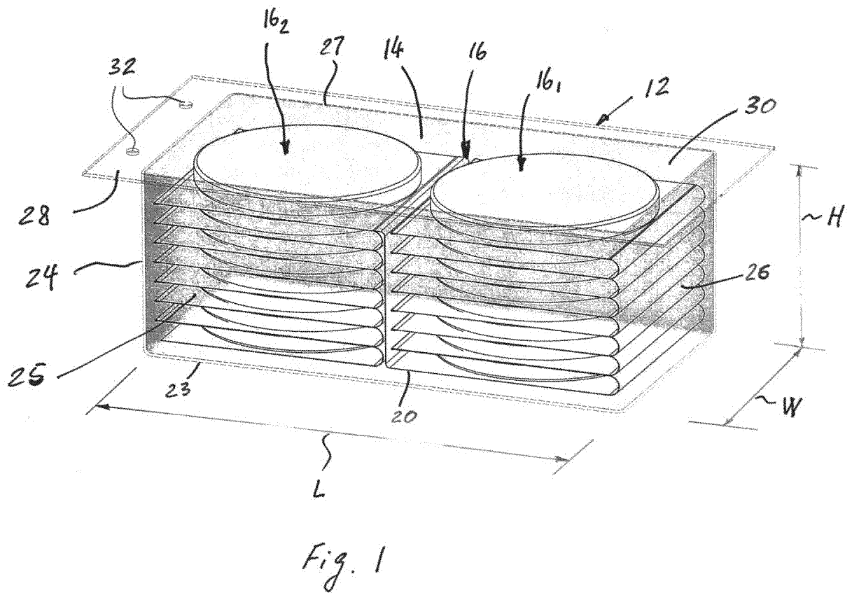

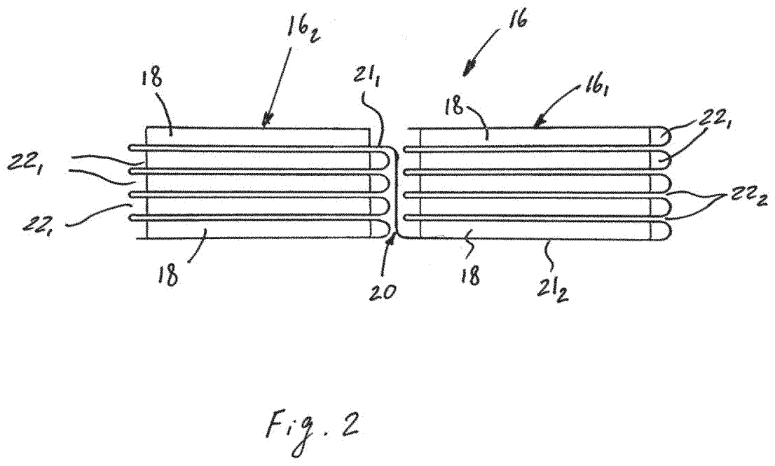

FIGS. 1-3 illustrate a first exemplary embodiment of a package of food products (or food product package) generally depicted with the reference numeral 10. The food product package 10 comprises a flexible hollow container (or receptacle) 12 having a storage (or interior) cavity 14 therein. A pack 16 of food products 18 is disposed inside the container 12 within cavity 14. The pack 16 includes at least one stack of food products 18 disposed inside the container 12 within cavity 14. Preferably the pack 16 includes two stacks 16₁ and 16₂ of food products 18 disposed inside the container 12 within cavity 14 adjacent to one another and having their major axes aligned in parallel. A single, continuous paper strip 20 interleaves between the food products 18 of the pack 16, i.e., of both the stacks 16₁ and 16₂, thereby separating each food product 18 from the food products 18 immediately adjacent it. The strip 20 preferably is made from a food grade paper. The paper strip 20 is interleaved between adjacent food products 18 in such a way that the interleaving paper strip 20 is preferably continuous throughout the pack 16, i.e., both of the stacks 16₁ and 16₂ disposed on the single strip 20, as best shown in FIG. 2

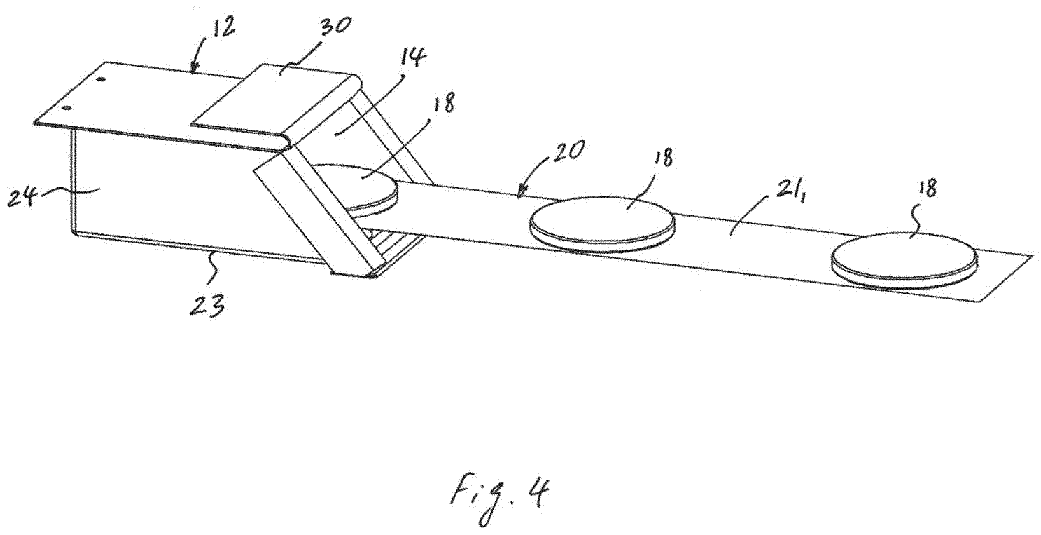

The container 12 is preferably a rectangular container, so that the major axes of the stacks 16₁ and 16₂ extend in parallel through the upper or longer side of container 12. The container 12 includes a bottom wall 23 and a continuous (i.e., endless, uninterrupted, or single) sidewall 24 extending outwardly from the bottom wall 23 and connected to the bottom wall 23. The bottom wall 23 and the continuous sidewall 24 collectively form the storage cavity 14 within the container 12. The storage cavity 14 within the container 12 is thus defined between the bottom wall 23 and the continuous sidewall 24. The continuous sidewall 24 of the container 12 includes a pair of opposite rectangular sidewall sections 25, and a pair of opposite rectangular end wall sections 26. As illustrated in FIGS. 1 and 4, the sidewall sections 25 and the end wall sections 26 extend outwardly from the bottom wall 23 and are preferably integral with the bottom wall 23 so as to form the container 12. As best shown in FIG. 1, the container 12 has a length L, a width W and a height H. The sidewall sections 25 of the container 12 are preferably longer than the end wall sections 26; i.e., L is greater than W. The container 12, including the bottom wall 23, the sidewall 24 and the flange 28, is preferably a unitary part, i.e., made as a single component. Preferably the container 12 is formed by a thermoforming process from a sheet of thin flexible thermoformable plastic or polymer sheet material, such as a thermoplastic.

The continuous sidewall 24 forms a continuous distal edge 27 opposite to the bottom wall 23 as best shown in FIG. 1. The continuous distal edge 27 of the container 12 defines an opening portion of the container 12. As further illustrated in FIG. 1, the container 12 preferably has an integral, continuous flange 28 surrounding the opening portion 27 of the container 12 and extending outwardly from the continuous distal edge 27 of the continuous sidewall 24, i.e., from the sidewall sections 25 and the end wall sections 26. Preferably, the sidewall 24 is perpendicular to the bottom wall 23, while the flange 28 is parallel to the bottom wall 23.

The food product package 10 further comprises a flexible peelable (or easy-peel) top film 30 adhesively bonded to the continuous distal edge 27 of the container 12 to seal the storage cavity 14 of the container 12 and encase the food products 18 therein. More specifically, the peelable top film 30 is adhesively bonded to the continuous flange 28 of the container 12. Therefore, the top film 30 is easily peelable from (or detachable from) the continuous flange 28 of the container 12 so as to open the storage cavity 14 and provide access to the food products 18 disposed within the container 12. The peelable top film 30 is bonded to the continuous flange 28 of the container 12 after the food products 18 are placed into the storage cavity 14 of the container 12. While we disclose adhesive bonding of the film 30 to the flange 28, other mechanisms, such as scorelines, lines of weakness, perforations and the like are available for bonding the film 30 to the flange 28 and/or to sidewall 25, and to allow the film 30 to be separated from container 12 and allow access to the interior of container 12. Further, we prefer that the film 30 be manufactured from the same material as used to manufacture container 12.

The peelable top film 30 and the container 12 may be sealed by suitable means to seal the package 10 in an airtight manner. In order to facilitate sealing the peelable top film 30 to the container 12, the flange 28 extends outwardly from the open upper end of the container 12 and the peelable top film 30 may be deposited onto flange 28 for sealing the container 12. If desired, the package 10 may receive an inert atmosphere, such as from nitrogen, carbon dioxide, and argon, in order to maximize the shelf life of the food products 18. Because the package 10 is thus sealed with the food products 18 and the inert gas, where desired, it may be deposited into a corrugated shipping container or the like and transported from the place where the food products 18 are manufactured to the place where they are to be cooked. Thus, the peelable top film 30 enables a user, such as a food preparer, to easily open a portion (or a limited area) of the container 12, defined herein as a pivotable tab 31, from the rest of the sidewall 24. Doing so opens the interior cavity 14 within the container 12 and provides access to the food products 18 disposed within the container 12.

The food products 18 preferably are patties, particularly raw meat or uncooked hamburger patties or sausage patties, packaged into stacks 16₁ and 16₂. While we prefer use of the invention with raw or uncooked patties or the like, those skilled in the art will appreciate that it can be used with frozen products. It is well known in the art that such patties 18 are typically relatively flat and usually disc-shaped or square-shaped food products that are to be cooked after being removed from the container 12. The patties 18 are typically made of minced or chopped food, especially meat. Preferably the patties 18 are raw meat hamburger patties 18 made from beef. While raw beef patties are disclosed, those skilled in the art will recognize that patties 18 made from other sorts of meat product, such as chicken and fish, or non-meat food products, such as vegetables, or a mixture thereof, may be utilized. The raw hamburger patties 18 are produced (or formed) by a patty forming machine (not shown).

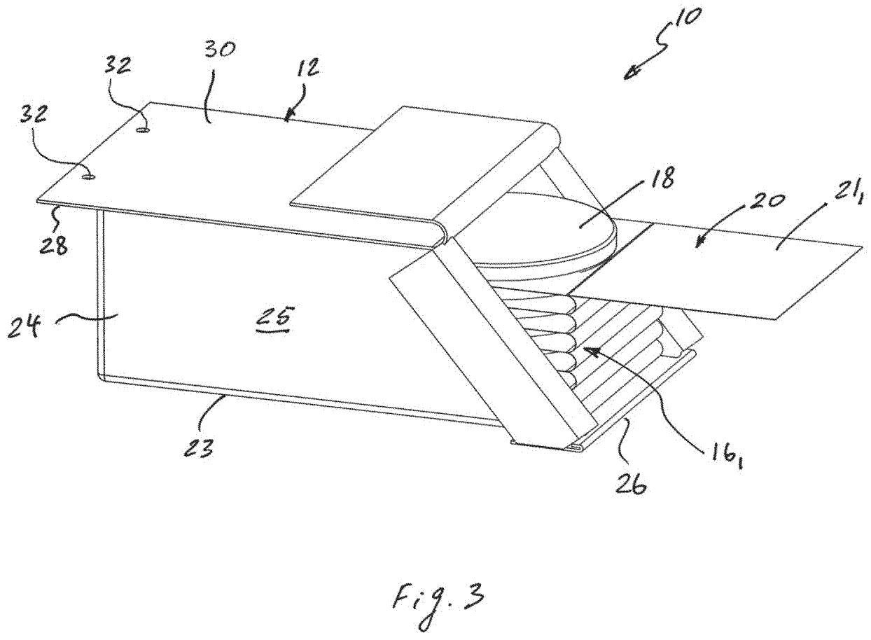

As described above, the pack 16 preferably includes two stacks 16₁ and 16₂ each including a plurality of the food products 18. The stacks 16₁ and 16₂ are disposed adjacent to each other along the length L of the container 12, i.e., along the longer sidewall sections 25 of the container 12, as best shown in FIG. 1. Moreover, the meat patties 18 of the stacks 16₁ and 16₂ are oriented so as to be parallel to the bottom wall 23 and the peelable top film 30, as best shown in FIGS. 1 and 3. The single paper strip 20 continuously interleaves between the food products 18 of the stacks 16₁ and 16₂, thereby separating each food product 18 from the food products 18 immediately adjacent (above and below) to it. A portion of the single paper strip 20 interleaving the food products 18 in one of the stacks 16₁ is connected to a portion of the same single paper strip 20 interleaving the food products 18 in adjacent stack 16₂, as shown in FIGS. 1, 2 and 5. The term “paper”, as used herein, designates any suitable strip-like wrapping material useful for enfolding the meat patties 18.

The interleaving paper strip 20 has an inner surface 21₁ in direct contact with the raw hamburger patties 18, and an outer surface 21₂ not being in contact with any of the raw hamburger patties 18, as best shown in FIG. 2. The interleaving paper strip 20 is pleated while the stacks 16₁ and 16₂ are being formed, i.e., folded across the width while alternating folding directions so as to provide a series of U-shaped pleats. In other words, the pleated paper strip 20 is folded into panels in an accordion-style manner. Each panel of a pair of the pleated paper strip 20 is connected by a common pleat tip (or fold line). Each of the pleat panels has a planar, rectangular face extending between the sequential pleat tips. As best shown in FIG. 2, the pleat tips are parallel to each other, and the pleat panels and pleats formed between the pleat tips are of a generally uniform size. Because the panels 21₂ contact each other, the strip 20 pulls easily from the package 10, because they are not frozen or otherwise secured together.

The pleats of the interleaving paper strip 20 include a plurality of receiving pleats 22₁ and a plurality of separating pleats 22₂. Each of the receiving pleats 22₁ receives and engages one of the food products 18 thereon, while each of the separating pleats 22₂ does not receive any of the food products 18 and separates two of the adjacent receiving pleats 22₁. As best shown in FIGS. 2 and 3, the receiving pleats 22₁ alternate with the separating pleats 22₂. Thus, each of the receiving pleats 22₁ is formed so that both sides of each meat patty 18 are engaged by the inner surface 21₁ of the interleaving paper strip 20, while each of the separating pleats 22₂ is empty and separates the adjacent hamburger patties 18 in the adjacent receiving pleats 22₁, as best shown in FIGS. 2 and 4. The food products 18 are thus stacked or arranged into the stacks 16₁ and 16₂ with the single paper strip 20 interleaved between the adjacent food products 18 in such a way that the interleaving paper strip 20 is continuous throughout both the stacks 16₁ and 16₂. Moreover, the interleaving paper strip 20 is configured to allow the food preparer to conveniently remove the meat patties 18 from the container 12. Pulling the paper strip 20 from the package 12 causes the food products 18 to be sequentially removed from package 12 with the top most patty 18 of the stack 16₁ being removed first and then the immediately below patty 18 being removed, as best shown in FIG. 3. Once all patties in stack 16₁ have been removed, the top most patty 18 in stack 16₂ is withdrawn, etc.

Use of the food product package 10 is straightforward. After the food product package 10 has been closed, the stacks 16₁ and 16₂ positioned within the cavity 14 and the package 10 sealed by film 30 adhered to flange 28, the food product package 10 is ready to be opened after being transported to the location where the food products 18 are to be cooked. The package 10 may be tilted, i.e., positioned at an oblique angle relative to the horizontal. Then the package 10 is opened by pulling all or a portion of the peelable top film 30 outwardly off the flange 28 of the container 12. One of the end wall sections 26 of the container 12 is then folded over and under the bottom wall 23 of the container 12. One end of the container 12 is thus opened so that the food products 18 may be removed from the container 12, as best shown in FIG. 3, preferably by pulling the strip 20. A portion of the sidewall 24 is folded over the rest of the sidewall 24, as best shown in FIG. 3. While FIG. 3 illustrates the end wall 26 having been severed from the adjacent sidewall sections 25, we have found that satisfactory results may be obtained where the material used to form container 12 is sufficiently flexible so that peeling strip 30 from flange 28 and pushing end wall 26 downwardly forms an opening or recessed area in end wall 26 through which patties 18 may be withdrawn.

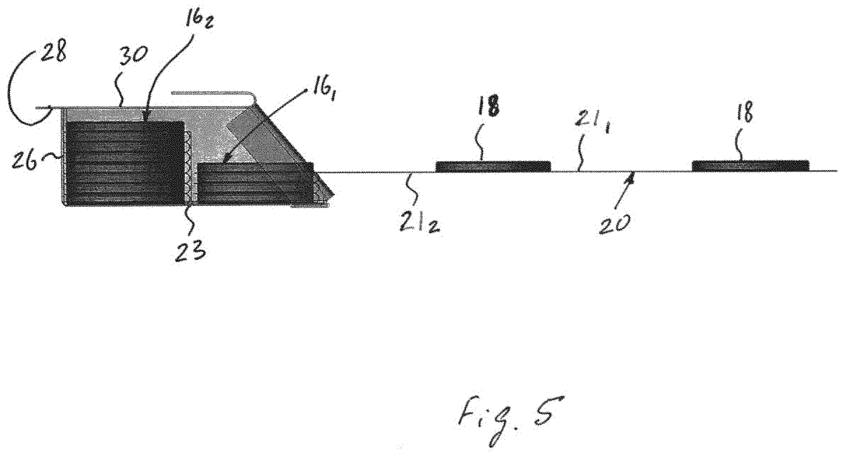

Pulling on the interleaving paper strip 20 allows individual food products 18 to be removed from the storage cavity 14. As an end of the interleaving paper strip 20 is pulled from package 12, the paper strip 20 begins to be withdrawn from the storage cavity 14, as best shown in FIGS. 3 and 4. As a consequence, the food products 18 on the strip 20 in spaced relation are correspondingly drawn out of the storage cavity 14 through the opening in end wall 26. Because food products 18 rest on the paper strip 20, food products 18 are removed one at a time from the package 12, as illustrated in FIGS. 4 and 5. Thus, the food products 18 are dispensed from the container 12 one at a time by pulling the paper strip 20 away from the container 12.

The paper strip 20 may be pulled from the container 12 manually or automatically, such as by a robotic or like mechanical device, so that no human hands need to touch the raw (uncooked) meat of the patties 18. Moreover, optionally, the food product package 10 may be provided with at least one aperture 32 provided to be engaged by a hook at the end use facility to secure the food product package 10 during the step of pulling the paper strip 20 away from the container 12. Accordingly, the food products 18 can be safely, easily and conveniently dispensed as needed from the food product package 10.

Some of the benefits of the novel food product package 10 of the present invention are that only one end of the container 12 needs to be opened. Further, any liquid seeping out of the raw meat products 18, such as blood, stays in the container 12 and kitchen workers do not need to touch any liquid in order to dispose of an empty container 12, thus reducing the risk of spreading pathogens.

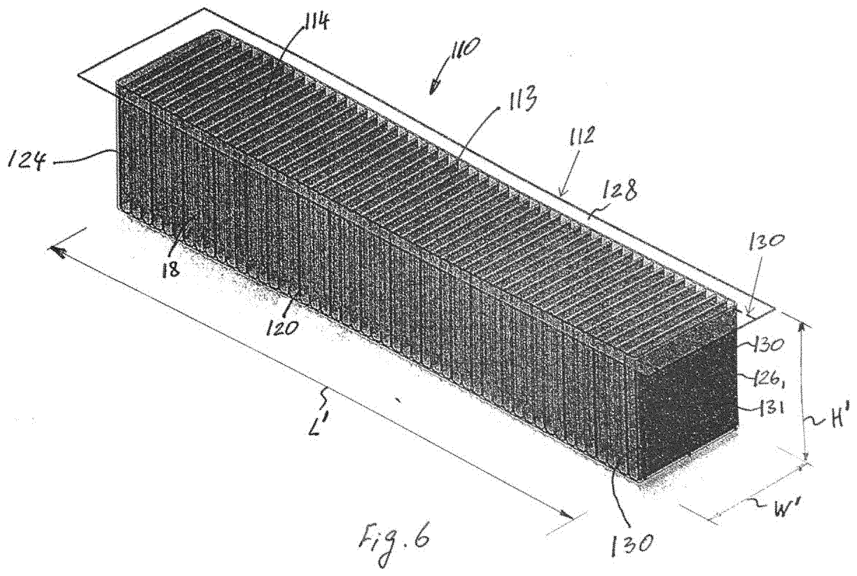

FIGS. 6-8 illustrate a second exemplary embodiment of a package of food products (or food product package) generally depicted with the reference numeral 100. The food product package 100 comprises a hollow container (or receptacle) 112 having a storage (or interior) cavity 114 therein. A stack 116 of food products 18 is disposed inside the container 112 within cavity 114. A single, continuous strip 120 interleaves between the food products 18, thereby separating each food product 18 from the food products 18 immediately adjacent it. The strip 120 preferably is made from a food grade paper. The paper strip 120 is interleaved between adjacent food products 18 in such a way that the interleaving paper strip 120 is preferably continuous throughout the stack 116. Unlike the embodiment in FIGS. 1-5 with spaced stacks 16₁ and 16₂, the stack 116 is single stack extending along the length L of container 112 with the major axis aligned with the end walls 126.

The container 112 is preferably a rectangular open top container. The container 112 includes a bottom wall 123 and a continuous (i.e., endless, uninterrupted or single) sidewall 124 extending outwardly from the bottom wall 123 and connected to the bottom wall 123, as best shown in FIGS. 6 and 9. The bottom wall 123 and the continuous sidewall 124 collectively form the storage cavity 114 within the container 112. The storage cavity 114 within the container 112 is thus defined between the bottom wall 123 and the continuous sidewall 124. The continuous sidewall 124 of the container 112 includes a pair of opposite rectangular sidewall sections 125₁ and 125₂, and a pair of opposite rectangular (preferably square) end wall sections 126₁ and 126₂. As illustrated in FIGS. 6 and 9, the sidewall sections 125₁, 125₂ and the end wall sections 126₁, 126₂ extend outwardly from the bottom wall 123 and are connected to the bottom wall 123 so as to form the container 112. As best shown in FIG. 6, the container 112 has a length L′, a width W′ and a height H′. The sidewall sections 125₁ and 125₂ of the container 112 are thus preferably longer than the end wall sections 126₁ and 126₂. As further illustrated FIG. 6, the sidewall 124 has a continuous flange 128 extending outwardly from sidewall sections 125₁ and 125₂ and the end wall sections 126₁ and 126₂. Preferably, the sidewall 124 is perpendicular to the bottom wall 123, while the flange 128 is parallel to the bottom wall 123.

The container 112, including the bottom wall 123 and the sidewall 124, is a unitary part, i.e., made as a single component. Preferably the container 112 is formed by thermoforming process from a sheet of thermoformable plastic or polymer sheet material, such as a thermoplastic. The package 110 has a top film 113 made from the same or different material as used to make the container 112 and sealed to the container 112 in order to encase the food products 18 therein. The top film 113 and container 112 may be sealed by suitable means, such as sonic welding, thermal welding, or the like in order to seal the package 110 in an airtight manner. In order to facilitate sealing the top film 113 to the container 112, the flange 128 may extend outwardly from the open upper end of container 112 and onto which the top film 113 may be deposited for sealing. Because the package 110 is thus sealed, it may be deposited into a corrugated shipping container or the like and transported from the place where the food products 18 are manufactured to the place where they are to be cooked.

The sidewall 124 of the container 112 is provided with two lines of weakness 130. The container 112 is preferably a plastic sheet, and the weakened lines 130 comprise perforations (i.e., perforation lines or lines of perforations) across the entire sidewall 124. The weakened lines 130 in the sidewall 24 are configured to form a pivotable or pop-out tab 131. FIGS. 6 and 9 show the pivotable tab 131 defined by the rectilinear lines of perforations 130 in the sidewall 124. The pivotable tab 131 may be pivoted or hinged outwardly from the sidewall 124 in order to sever the perforations in the weakened lines 130 to form a side opening 125 in the sidewall 124 of the container 112. Thus, the weakened lines 130 enable a user, such as a food preparer, to easily separate a portion (or a limited area) of the sidewall 124 of the container 112, defined herein as the pivotable tab 131, from the rest of the sidewall 124. Doing so opens the interior cavity 114 within the container 112 and provides access to the food products 18 disposed within the container 112. The weakened lines 130 can be formed by score marks (or score lines), perforations (or perforation lines, or lines of perforations), reduced (or weak) thicknesses, or similar treatment of the container 112, to facilitate severing of the sidewall 124 in order to open the container 112 and allow access to the food products 18. Pulling on the interleaving paper strip 120 allows individual food products 18 to be exposed, so that the food products 18 may be removed from the container 112. The weakened lines 130 allow the user of the food product package 110 to tear the end portion of the container 112, such as at the end wall section 126₁, to facilitate removal of the food products 18 and thus allow dispensing of the food products 18 from the container 112. Thus, according to the exemplary embodiment, the end wall section 126₁ that is separated, or can be separated, from the sidewall 124 along the weakened lines 130 functions as the pivotable tab 131. While we disclose the weakened lines, such as scorelines, perforations and the like, to easily separate a portion of the container 112, other mechanisms, such as adhesive bonding of the top film 113 to the flange 128, as described in the first exemplary embodiment of the present invention, or the like, are available to allow a portion of the container 112 to be separated and allow access to the interior of container 112.

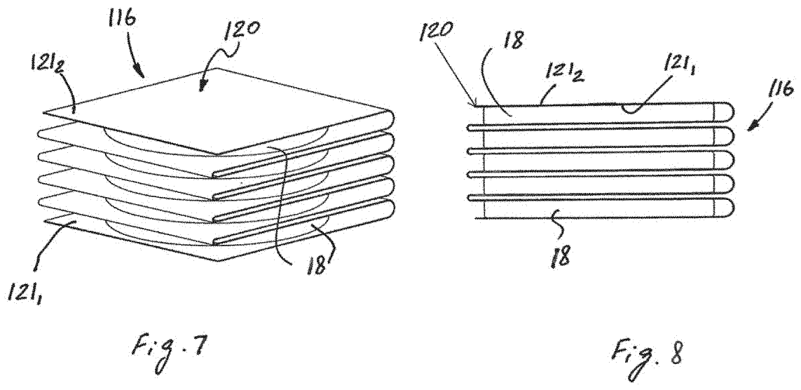

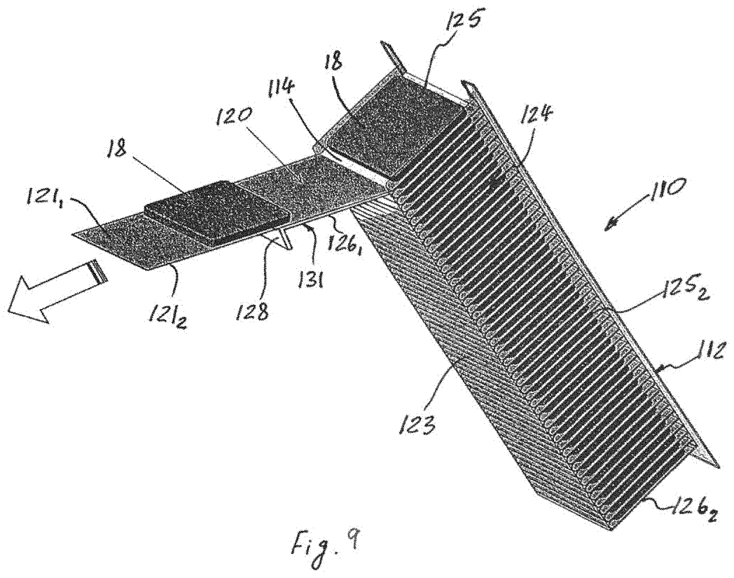

The stack 116 of the food products 18 includes a plurality of the food products 18. The interleaving paper strip 120 has an inner surface 121₁ being in direct contact with the raw hamburger patties 18, and an outer surface 121₂ not being in contact with any of the raw hamburger patties 18. The interleaving paper strip 120 is pleated, i.e., folded by a certain width while alternating folding directions so as to provide a series of U-shaped pleats. In other words, the pleated paper strip 120 is folded into panels in an accordion-style manner. Each panel of a pair of the pleated paper strip 120 is connected by a common pleat tip (or fold line). Each of the pleat panels has a planar, rectangular face extending between the pleat tips. As shown in FIGS. 7 and 8, the pleat tips are parallel to each other, and the pleat panels and pleats formed between the pleat tips are of a generally uniform size. Because the outer surfaces 121₂ contact each other, the strip 120 can be easily withdrawn from the container 112 because the panels 121₂ are not frozen or otherwise secured together.

The pleats of the interleaving paper strip 120 include a plurality of receiving pleats 121₁ and a plurality of separating pleats 121₂. Each of the receiving pleats 121₁ receives and holds one of the food products 18 thereon, while each of the separating pleats 121₂ does not receive any of the food products 18 and separates two of the adjacent receiving pleats 121₁. As best shown in FIGS. 7 and 8, the receiving pleats 121₁ alternate with the separating pleats 121₂. Thus, each of the receiving pleats 121₁ is formed so that both sides of each meat patty 18 are engaged by the inner surface 121₁ of the interleaving paper strip 120, while each of the separating pleats 121₂ is empty and separates the adjacent hamburger patties 18 in the adjacent receiving pleats 121₁. The food products 18 are thus stacked or arranged in the stack 116 with the single paper strip 120 interleaved between the adjacent food products 18 in such a way that the interleaving paper strip 120 is continuous throughout the stack 116. Moreover, the interleaving paper strip 120 is configured to allow the food preparer to conveniently remove the meat patties 18 from the container 112.

Use of the food product package 110 is straightforward. After the food product package 110 has been closed due to the stack 116 having been positioned within the cavity 114 and the package 110 sealed, the food product package 110 is ready to be opened after being transported to the location where the food products 18 are to be cooked. The package 110 may be tilted, i.e., positioned at an oblique angle relative to the horizontal, as shown in FIG. 9. Then the end wall section 126₁, as shown in FIG. 9, is pulled outwardly away from the container 112 to tear the end wall section 126₁ along the weakened lines 130 to separate the end wall section 126₁ from the sidewall 124, thus opening the storage cavity 114 within the container 112. Next, an end of the interleaving paper strip 120 is pulled and thereby the paper strip 120 begins to pull away from the storage cavity 114. As a consequence, the food products 18 are drawn out of the storage cavity 114 while resting on the paper strip 120 and removed one at a time from the package 112, as illustrated in FIG. 9.

The paper strip 120 may be pulled from the container 112 manually or automatically, such as by a robotic or like mechanical device, so that no human hands need to touch raw (uncooked) meat of the patties 18. Accordingly, the food products 18 can be safely, easily and conveniently dispensed as needed from the food product package 110.

Some of the benefits of the novel food product package 110 of the present invention are that only one end of the container 112 needs to be open. Further, any liquid seeping out of the raw meat products 18, such as blood, stays in the container 112 and kitchen workers do not need to touch any liquid in order to dispose of an empty container 112, thus reducing the risk of spreading pathogens.

The foregoing description of the exemplary embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. A food product package for storing and dispensing food products, the food product package comprising:
a container including a bottom wall and a continuous sidewall extending from the bottom wall and connected to the bottom wall, the bottom wall and the continuous sidewall forming a storage cavity within the container;
a plurality of food products disposed within the storage cavity;
a single strip interleaving the food products; and
a top film secured to the continuous sidewall of the container and sealing the storage cavity within the container;
the top film removable from the continuous sidewall to open the storage cavity and provide access to the food products disposed within the container.

2. The food product package according to claim 1, wherein the container is rectangular and formed from a flexible material.

3. The food product package according to claim 2, wherein the continuous sidewall includes a pair of opposite sidewall sections and a pair of opposite end wall sections, and wherein the sidewall sections and the end wall sections extend outwardly from the bottom wall and are connected to the bottom wall so as to form the container.

4. The food product package according to claim 1, wherein the continuous sidewall forms a continuous distal edge of the container, and wherein the top film is adhesively bonded to the continuous distal edge of the continuous sidewall of the container.

5. The food product package according to claim 4, wherein the sidewall has a continuous flange extending outwardly from the continuous sidewall.

6. The food product package according to claim 5, wherein the sidewall is perpendicular to the bottom wall, and wherein the flange is parallel to the bottom wall.

7. The food product package according to claim 5, wherein the top film is bonded onto the continuous flange of the continuous sidewall.

8. The food product package according to claim 1, wherein food products are arranged in two stacks, and wherein the single strip is interleaved between adjacent food products so that the interleaving single strip is continuous throughout the two stacks.

9. The food product package according to claim 8, wherein one portion of the single strip, which separates the food products of one of the stacks, is connected to another portion of the single strip, which separates the food products of the adjacent stack.

10. The food product package of claim 3, wherein the sidewall has a continuous flange extending outwardly beyond at least one of the end wall sections of the container.

11. The food product package according to claim 1, wherein the single strip has an inner surface in direct contact with the food products, and an outer surface not in contact with the food products.

12. The food product package according to claim 11, wherein the single strip is pleated and includes a plurality of receiving pleats and a plurality of separating pleats, wherein each of the receiving pleats receives one of the food products, and wherein the separating pleats do not receive any of the food products.

13. The food product package according to claim 12, wherein each of the separating pleats separates two adjacent receiving pleats.

14. The food product package according to claim 1, wherein the food products are patties made from meat product or non-meat food products.

15. The food product package according to claim 14, wherein the patties are raw meat hamburger patties.

16. The food product package according to claim 1, wherein the container is formed from a thermoformed polymer material.

17. The food product package of claim 1, wherein the container has a flange extending outwardly from an upper end off the container for receiving the top film, the top film and flange being secured together.

18. The food product package according to claim 1, wherein the single strip is formed from paper.

19. A food product package for storing and dispensing uncooked meat patties, the food product package comprising:
a container including a bottom wall and a continuous sidewall extending from the bottom wall and connected to the bottom wall, the bottom wall and the continuous sidewall forming a storage cavity within the container;
a plurality of uncooked meat patties disposed within the storage cavity;
a single strip interleaving the uncooked meat patties; and
a top film adhesively bonded to the continuous sidewall to seal the storage cavity within the container;
the top film peelable from the continuous sidewall to open the storage cavity and provide access to the uncooked meat patties disposed within the container.

20. A method of using a food product package, the method including the steps of:
providing a food product package for storing food products, the food product package comprising a container including a bottom wall and a continuous sidewall extending outwardly from the bottom wall, a plurality of food products disposed in the container with a single strip interleaving the food products, and a peelable top film bonded onto the continuous sidewall of the container;
pulling the peelable top film outwardly away from the sidewall of the container to open the container; and
dispensing the food products from the container one at a time by pulling the paper strip away from the container.
